(19) United States
(12) Patent Application Publication
(10) Pub. No.: US 2011/0254430 A1
(43) Pub. Date: Oct. 20, 2011

(54) PRODUCTION METHODS OF ELECTRON EMITTING DEVICE, ELECTRON BEAM APPARATUS, AND IMAGE DISPLAY APPARATUS

(75) Inventor: Tamayo Hiroki, Zama-shi (JP)

(73) Assignee: CANON KABUSHIKI KAISHA, Tokyo (JP)

(21) Appl. No.: 13/082,924

(22) Filed: Apr. 8, 2011

(30) Foreign Application Priority Data
Apr. 15, 2010 (JP) 2010-093791

(51) Int. Cl. H01J 1/02; H01J 9/02

(52) U.S. Cl. 313/326; 445/35

(57) ABSTRACT

A production method of an electron emitting device is provided, which reduces occurrence of a leak current between a gate and a cathode to which a voltage for driving an electron source is applied. The electron emitting device includes an insulating member having a concave portion on a surface thereof, a gate electrode formed on the insulating member and located opposing the concave portion, a cathode formed on an edge of the concave portion and having a protrusion protruding to the gate electrode. The production method includes steps of forming the concave portion and of forming the cathode after forming the convex portion protruding to the gate electrode at the edge of the concave portion. These steps are performed in this order.

### BACKGROUND OF THE INVENTION

1. Field of the Invention

The present invention relates to a production method of an electron emitting device, an electron beam apparatus using the electron emitting device, and an image display apparatus using the electron beam apparatus.

2. Description of the Related Art

Conventionally, an electron emitting device of a type, in which a lot of electrons emitted from a cathode and hitting a gate electrode opposing the cathode are scattered, and then taken out as electrons, has been known. As a device emitting electrons in such a style, Japanese Patent Application Laid-Open No. 2009-272298 discusses a laminated type electron emitting device. In this invention, the electron emitting device includes an insulating member having a concave portion on a surface thereof, a cathode having a protrusion located over an outside surface of the insulating member and an inside surface of the concave portion, a gate located at an outside surface of the insulating member and opposing the protrusion, and an anode located opposing the protrusion via the gate.

The electron emitting device discussed in Japanese Patent Application Laid-Open No. 2009-272298 can reduce degradation of electron emitting characteristics with the passage of time. However, in the electron emitting device discussed in Japanese Patent Laid Open No. 2009-272298, a convex portion to be a cathode is formed at an opening of the concave portion after forming the concave portion at the insulating member. Since the opening of the concave portion is wide at an initial time of forming the cathode, there may be a case in which a material of the cathode can go around an inside of the concave portion, so that the material of the cathode can cause a leak current between the gate and the cathode. In this case, a voltage for driving an electron source is applied between the gate and the cathode.

### SUMMARY OF THE INVENTION

According to an aspect of the present invention, a method of an electron emitting device which includes an insulating member having a concave portion on the surface thereof, a gate electrode located being opposing the concave portion, and a cathode having a protrusion located at an edge of the concave portion and protruding to the gate electrode. The production method includes a step for forming the concave portion, a step for forming the cathode after forming the convex portion protruding to the gate electrode at the edge of the concave portion, and these steps are performed in this order.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1A to FIG. 1D illustrate a configuration of an electron emitting device according to an exemplary embodiment of the present invention.

FIG. 2 illustrates a potential configuration at a time of measuring electron-emission characteristics.

FIG. 3A to FIG. 3H illustrate a production method of the electron emitting device according to an exemplary embodiment of the present invention.

FIG. 4A to FIG. 4D illustrate a relationship between the convex portion at an entrance of a recessed portion and an angle of view.

FIG. 5A to FIG. 5C illustrate an effect of the convex portion at the entrance of the recessed portion.

FIG. 6A to FIG. 6C illustrate a configuration of the electron emitting device produced in an exemplary embodiments and a comparative example.

FIG. 7A to FIG. 7G illustrate the production method of the electron emitting device according to a first exemplary embodiment.

FIG. 8A to FIG. 8E illustrate the production method of the electron emitting device according to the comparative example.

FIG. 9 illustrates an image display apparatus in a seventh exemplary embodiment.

### DESCRIPTION OF THE EMBODIMENTS

Various exemplary embodiments, features, and aspects of the invention will be described in detail below with reference to the drawings.

However, sizes, material qualities, shapes, and relative locations of the configuration parts described in the following exemplary embodiments does not limit the aspect of the present invention as long as there are no particular descriptions.

### [Abstract of the Device]

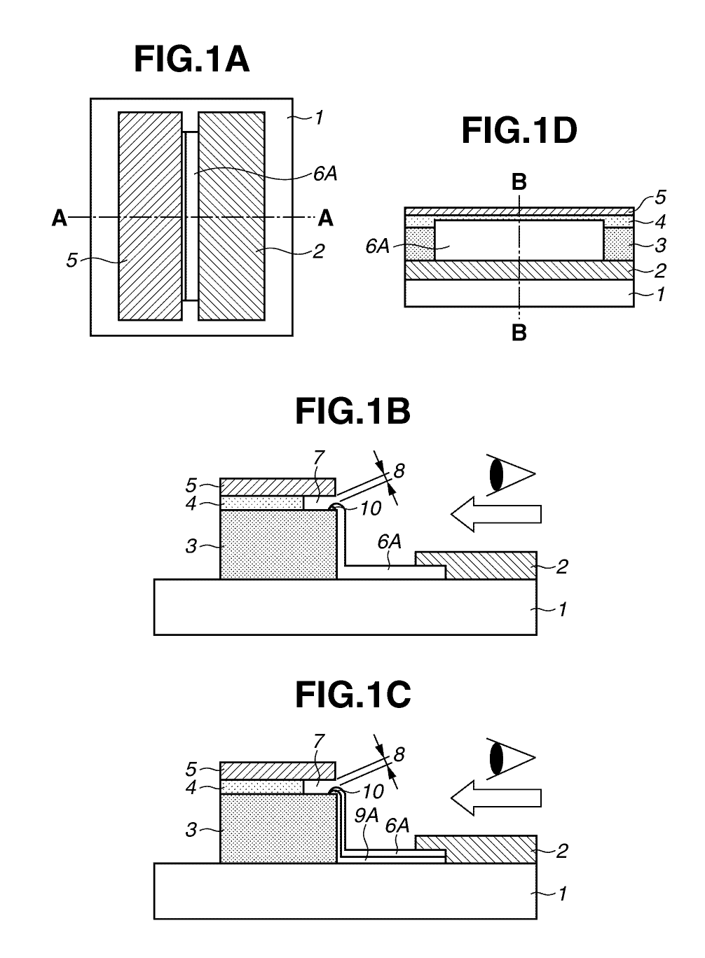

FIGS. 1A to 1D are schematic views illustrating a configuration of an electron emitting device produced by a production method according to an exemplary embodiment of the present invention. FIG. 1A is a top plane view, FIG. 1B is a cross sectional view taken along the line A-A in FIG. 1A, and FIG. 1D is a side view of the device as viewed from an arrow direction in FIG. 1B.

In FIGS. 1A to 1D, an insulating member is arranged on a substrate 1. The insulating member according to the present exemplary embodiment includes a concave portion 7 (hereinafter it can be referred to as “a recessed portion”). The insulating member is configured with, for example, a first insulating layer 3 and a second insulating layer 4, as illustrated in FIG. 1B. In this configuration, the concave portion 7 is configured with a part of an upper surface of the first insulating layer 3 on which the second insulating layer 4 is not formed and a side surface of the second insulating layer 4.

Hereinafter, the two surfaces configuring the concave portion 7 can be referred to as “a inside surface of the recessed portion 7”. A gate electrode 5 is located at a surface of the second insulating layer 4, opposing the concave portion 7. A convex portion 10 is located at an edge of the concave portion 7 (an entrance of the recessed portion 7) and protrudes toward the gate electrode 5.

A cathode 6A is provided after providing the convex portion 10, and has a protrusion protruding toward the gate electrode 5. The cathode 6A is provided from an edge of the concave portion 7, in which the convex portion 10 is provided, to on the substrate 1 along a side surface of the first insulating layer 3. A gap 8 is a shortest distance from a top end of the protrusion of the cathode 6A to a bottom surface of the gate electrode 5 (a part opposing the concave portion 7). By the gap 8, an electric field for emitting electrons is formed.

An electrode 2 is provided on the substrate 1 and electrically connected to the cathode 6A. Although not illustrated in FIG. 1, at a position opposing the cathode 6A via the gate electrode 5, the electron emitting device includes an anode electrode located opposing a top end of the cathode 6A. The anode is set to have a higher potential than the other portions, for example, the gate electrode 5, the cathode 6A, and substrate 1. The electron beam apparatus is configured with the anode electrode and the electron emitting device in FIG. 1.

In addition, the configuration in FIG. 1B can be a configuration in FIG. 1C. FIG. 1C is a cross-sectional view taken along the line A-A in FIG. 1A. The configuration in FIG. 1C is different from the configuration in FIG. 1B in the following point. That is, a material of the convex portion 10 is not only used to provide the convex portion 10 at the edge of the concave portion 7 but also used to provide a part from the edge of the concave portion 7 to on the substrate 1 along the side face of the first insulating layer 3. Since the convex portion 10 is formed at the edge of the concave portion 7 before forming the cathode, it may be prevented that the cathode material turns into the inside of the concave portion 7 when the cathode is film-formed. Therefore, the present embodiment may prevent the occurrence of the leak current between the gate and the cathode, and provide the production method of the electron-emission device having a steady operation performance. Further, the present embodiment may provide an electron beam apparatus using the electron-emission device and an image display apparatus including the electron beam apparatus as discussed below.

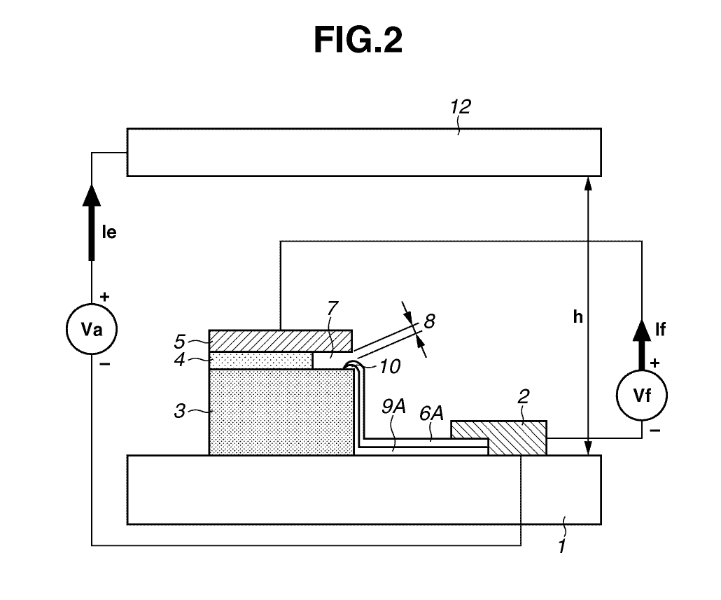

FIG. 2 illustrates the electron emitting device produced by the production method according to the present exemplary embodiment. FIG. 2 illustrates a relationship of a power source and a potential when electron-emission characteristics are measured. Vf is a voltage applied between the cathode 6A and the gate electrode 5, If is a current flowing between the cathode and the gate electrode, Va is a voltage applied between the cathode 6A and the anode electrode 12, and Ie is a electron-emission current.

In FIG. 2, apart of electrons emitted from the cathode 6A to the gate electrode 5 opposing the cathode 6A reaches the anode electrode 12. The remained electrons reach the gate electrode 5, are scattered one time or more, and then reach the anode electrode 12 or disappear on the gate electrode 5. The current reaching the anode electrode 12 in this manner is an electron-emission current.

On the other hand, a leak current is a current in which electrons flow from the cathode 6A to the gate electrode 5 through the surface or the inside of the first insulating layer 3 and the second insulating layer 4. For example, if a conductive material adheres on the inside surface of the recessed portion 7, the material becomes a rout of the leak current. The leak current is an invalid current which does not contribute at all to the electron-emission current reaching the anode electrode 12, and not only increases power consumption but also disturbs the stability of the electron-emission characters, so that it is desirable to prevent as much as possible.

### [Abstract of the Production Method]

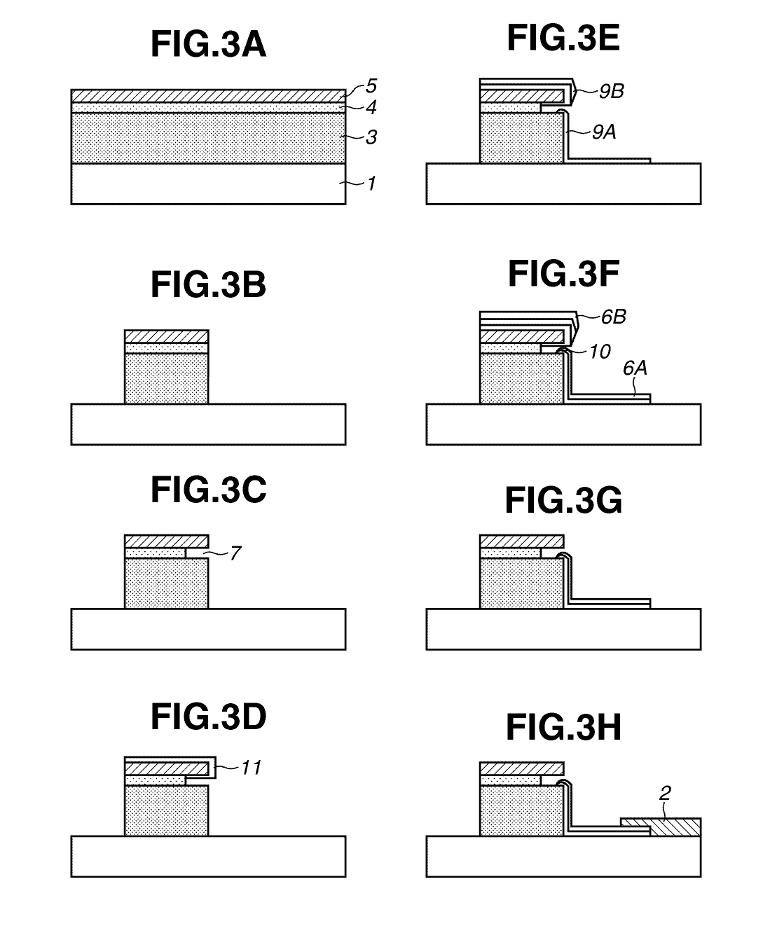

FIGS. 3A to 3H are schematic cross-sectional views illustrating the production method of the electron emitting device according to the present exemplary embodiment. In FIG. 3A, the first insulating layer 3, the second insulating layer 4, and the gate electrode 5 are laminated in this order on the substrate 1 by a conventional vacuum film-forming technology, for example, a chemical vapor deposition (CVD) method, a vacuum deposition method, a sputtering method.

The substrate 1 is for mechanically supporting the device. As a material of the substrate 1, a quartz glass, a glass reducing the content of impurities such as sodium, a blue sheet glass, and a silicon substrate are used. As functions for the substrate 1, the material is to have not only high mechanical strength but also resistance for alkalis or acids, such as dry etching, wet etching, or developer. Further, when the device is used for an integrated product such as a display panel, the material is to have a small difference of a heat expansion coefficient with respect to film-forming materials and other laminating members. Furthermore, the materials in which alkali elements hardly diffuse from the inside of the glass by a heat treatment are used.

The first insulating layer 3 is an insulating layer made of a material having a superior processability. As the material of the first insulating layer 3, silicon nitride (SiN or SixNy) or silicon dioxide (SiO₂) is used. The thickness of the first insulating layer 3 is set within a range from 5 nm or more to 50 μm or less, may be from 5 nm or more to 800 nm or less. The lower limit value of the first insulating layer 3 is the minimum thickness with which sufficient electron source efficiency can be obtained, and the upper limit value of the first insulating layer 3 is the maximum thickness when easiness in the production is considered.

The second insulating layer 4 is an insulating layer made of a material having a superior processability. As a material of the second insulating layer 4, SiN or SiO₂, or SiO₂ is used. The thickness of the second insulating layer 4 is set within a range from 5 nm or more to 500 nm or less, or from 5 nm or more to 50 nm or less. When the electron-emission characters are considered, it is to set the thickness of the second insulating layer 4 to be within a range from 10 nm or more to 30 nm or less. The lower limit value of the second insulating layer 4 is the minimum thickness with which a sufficient effect can be obtained as an inter-insulating layer, and the upper limit value of the second insulating layer 4 is the maximum thickness with which the sufficient electron source efficiency can be obtained.

For example, SixNy is used as the material of the first insulating layer 3. An insulating material such as SiO₂, a phosphosilicate glass (PSG) with a high phosphorous concentration, or a borosilicate glass (BSG) with a high boron concentration is used as the material of the second insulating layer 4. In addition, since the recessed portion 7 is formed after laminating the first insulating layer 3 and the second insulating layer 4, etching rates of the first insulating layer 3 and the second insulating layer 4 should be set to have different a value respectively. In one embodiment, a selection ratio for the etching rate between the first insulating layer 3 and the second insulating layer 4 is 10 or more, or 50 or more.

A material of the gate electrode 5 is to have high thermal conductivity and a high melting point in addition to electric conductivity. For example, a metal such as beryllium (Be), magnesium (Mg), titanium (Ti), zirconium (Zr), hafnium (Hf), vanadium (V), niobium (Nb), tantalum (Ta), molybdenum (Mo), tungsten (W), aluminum (Al), copper (Cu), nickel (Ni), chromium (Cr), gold (Au), platinum (Pt), or palladium (Pd) or an alloy of these metals, a carbide such as titanium carbide (TiC), zirconium carbide (ZrC),hafniumcarbide (HfC), tantalum carbide (TaC), silicon carbide (SiC), or tungsten carbide (WC), a boride such as hafnium boride (HfB₂), zirconium boride (ZrB₂), lanthanum boride (LaB₆), cerium boride (CeB₆), yttrium boride (YB₄), or gadolinium boride (GdB₄), a nitride such as titanium nitride (TiN), zirconium nitride (ZrN), hafnium nitride (Hf), or tantalum nitride (TaN), a semiconductor such as silicon (Si) or germanium (Ge), an organic polymer, amorphous carbon, graphite, diamond-like carbon, or carbon or a carbon composite in which diamonds are dispersed, can be suitably used.

The thickness of the gate electrode 5 is set within a range from 5 nm or more to 500 nm or less, may be from 10 nm or more to 100 nm or less. The lower limit value of the gate electrode 5 is the minimum thickness in which the second insulating layer 4 can exert a sufficient effect as an inter-insulating layer. The upper limit value of the gate electrode 5 is the maximum thickness with which sufficient electron source efficiency can be obtained.

Then, in FIG. 3B, after forming a resist pattern on the gate electrode 5 by a photolithography technology, the gate electrode 5, the second insulating layer 4, and the first insulating layer 3 are processed in this order by an etching method. In such an etching processing, a reactive ion etching (RIE) can be generally used. The RIE can perform precise etching processing of a material by turning an etching gas into plasma state and irradiating the material with the plasma.

As a processing gas in this case, when an object material to be processed can form a fluoride, a fluorine based gas such as carbon tetra-fluoride (CF₄), tri-fluoro methane (CHF₃), or sulfur hexa-fluoride (SF₆) can be selected. When an object material to be processed can form a chloride, such as silicon or aluminum, a chlorine based gas such as a chlorine gas (Cl₂) or boron tri-chloride (BCl₃) can be selected. Further, for increasing the selection ratio with a resist, for securing a flatness of the etching surface, and for increasing an etching rate, a hydrogen gas, an oxygen gas, and an argon gas can be added when necessary.

Then, in FIG. 3C, the second insulating layer 4 is processed by using etching process to form the recessed portion 7. When the second insulating layer 4 is a material made of SiO₂, a mixed solution of ammonium fluoride and fluoric acid which is generally called a buffer fluoric acid (BHF) can be used. When the second insulating layer 4 is a material made of SixNy, the material can be etched by using a heated phosphoric acid based etching solution.

A depth of the recessed portion 7 (a distance from the side surface of the first insulating layer 3 to the side surface of the second insulating layer 4 constituting the recessed portion 7) greatly affects the leak current after forming the device. The leak current value becomes low as the depth of the recessed portion 7 is formed to be deep. The is because, due to the distance of the inner surface, which becomes to the rout of the leak current, of the recessed portion 7 being extended, the turning of the cathode material into the recessed portion 7 and the effect of remaining cathode materials become small. However, if the distance is formed too deep, the other problems may occur, for example, a deformation of the gate electrode 5, so that the depth of the recessed portion 7 is formed about from 30 nm or more to 200 nm or less.

Then, as illustrated in FIG. 3D, a separating layer 11 is formed on the gate electrode 5. The separating layer 11 is formed for separating the cathode 6B, which is deposited in the next step, from the gate electrode 5. Therefore, the separating layer 11 is formed by a method, for example, oxidizing the gate electrode 5 to form an oxide layer, or electro-plating separation metal to adhere on the gate electrode 5.

Then, the convex portion 10 is provided at the entrance of the recessed portion 7. As the providing method of the convex portion 10, as illustrated in FIG. 3E, there is an oblique deposition method in which a material of the convex portion 10 is slantingly film-formed by conventional vacuum film-forming technologies, such as, a vapor film-forming method, for example, a CVD method, a vacuum deposition method, and a sputtering method.

A layer 9A is formed by film-forming the material of the convex portion 10 from the entrance of the recessed portion 7 to on the substrate 1 along the side surface of the first insulating layer 3, and forms the convex portion 10 extending to the gate electrode 5 at the entrance of the recessed portion 7. In addition, at this time, the material of the convex portion 10 is adhered also on the gate electrodes 5, so that the layer 9B is formed on the gate electrode 5 and the side surface of the gate electrode 5. As another method, the convex portion 10 can be formed by patterning the first insulating layer 3.

A height of the convex portion 10 is set within a range of 50% or more to 85% or less of a thickness of the recessed portion 7 (a thickness of the second insulating layer 4). When the height of the convex portion 10 is 50% of the thickness of the recessed portion 5, the invading amount of the metal particles into the recessed portion 7 can be reduced about half, so that the leak current can be reduced.

Therefore, when the height of the convex portion 10 is 50% or less of the thickness of the recessed portion 7, the effect to prevent the leak current becomes small, so that it is not preferable. Further, when the height of the convex portion 10 is 85% or more of the thickness of the recessed portion 7, the film-thickness of the cathode, which is film-formed after film-forming the convex portion 10, becomes too thin, so that an electric resistance of the cathode becomes high, or the cathode becomes an un-continuous layer and an electric resistance value becomes unstable. Thus, it is not preferable.

As a material of the convex portion 10, for example, a material which has a superior processabilty and insulation property may be used. More specifically, SiN (SixNy), SiO₂, PSG, BSG, silicon oxy-fluoride (SiOF), silicon oxy-carbide (SiOC), silicon carbo-nitride (SiCN), titanium dioxide (TiO₂), chromium oxide (Cr₂O₃), tantalum oxide (TaO), strontium oxide (SrO), and cobalt oxide (CoO) are used. Further, the convex portion 10 does not necessarily need to have insulation property, and a high electric resistance film such as Si, tin oxide (SnO₂) , antimony oxide (SbO₂), or tungsten germanium oxy-nitride (WGeON) can be used. The electric resistivity of the high electric resistance film may be 10⁻⁴ Ωm or more.

Then, in FIG. 3F, the cathode 6A is provided by the conventional vacuum film-forming technologies, such as a CVD method, a vacuum deposition method, or a sputtering method. Te cathode 6A is formed by performing the oblique deposition of the material of the cathode 6A from the entrance of the recessed portion 7, in which the convex portion 10 is provided, to on the substrate 1 along the side surface of the insulating layer 3.

In addition, at this time, the material of the cathode is adhered also on the gate electrode 5, and a cathode 6B is formed on the layer 9B. When the electron-emission characteristic is considered, the thickness of the cathode 6A is to be at least about 5 nm. In one embodiment, the gap 8 to be formed from 4 nm or more to 12 nm or less, when the gap 8 is observed by a transmission electron microscope (TEM).

The material of the cathode 6A should just have electric conductivity and field emission characteristic. Generally, the material of the cathode 6A has a high melting point of 2000° C. or higher, and a work function of 5 eV or less. Further, the material of the cathode 6A hardly forms a chemical reaction layer such as an oxide layer or can easily remove such a reaction layer. For example, metal such as Hf, V, Nb, Ta, Mo, W, Au, Pt, or Pd or alloy of these metals, a carbide such as TiC, ZrC, HfC, TaC, SiC, or WC, a boride such as HfB₂, ZrB₂, LaB₆, CeB₆, YB₄, or GdB₄, a nitride such as TiN, ZrN, HfN, or TaN, amorphous carbon, graphite, diamond-like carbon, or carbon and a carbon compound in which diamonds are dispersed, can be used.

Then, in FIG. 3G, the separation layer 11 is removed by etching, and thus the layer 9B and the cathode 6B, which are on the gate electrode 5, are removed.

Then, in FIG. 3H, an electrode 2, which is for taking an electric conduction to the cathode 6A, is formed by conventional vacuum film-forming technologies such as a CVD method, a vacuum deposition method, or a sputtering method, and a photolithography technology. The electrode 2 is a material having an electric conductivity. For example, a metal such as Be, Mg, Ti, Zr, Hf, V, Nb, Ta, Mo, W, Al, Cu, Ni, Cr, Au, Pt, or Pd or an alloy of these metals can be used. Further, a carbide such as TiC, ZrC, HfC, TaC, SiC, or WC, a boride such as HfB₂, ZrB₂, LaB₆, CeB₆, YB₄, or GdB₄, or a nitride such as TiN, ZrN, or HfN can be also used.

Further, a semiconductor such as Si or Ge, an organic polymer, amorphous carbon, graphite, diamond-like carbon, carbon and a carbon compound in which diamonds are dispersed can be used. A thickness of the electrode 2 is set within a range from 50 nm or more to 5 mm or less, may be from 50 nm or more to 5 μm or less.

The lower limit value of the electrode 2 is the minimum thickness which can secure a sufficient electric conductivity. The higher limit value of the electrode 2 is the maximum thickness when easiness of the production is considered. The electrode 2 can be made of the same material as the gate electrode 5 or a different material, and can be formed by the same forming method as the gate electrode 5 or the different forming method. However, in the gate electrode 5, there is a case in which the thickness of the gate electrode 5 is set to be in a thinner range than the thickness of the electrode 2, so that the gate electrode 5 may be made of a low electric resistance material.

Further, in the above-described exemplary embodiment of the production method, the separation layer 11 is formed to remove the cathode 6B on the gate electrode 5. However, the configuration in which the cathode 6B is remained on the gate electrode 5 may be possible. However, in this case, for securing the electric connection between the gate electrode 5 and the cathode 6B, a part of the layer 9B is to be removed by patterning before forming the cathode 6B.

### [Effect of Forming the Convex Portion at the Entrance of the Recessed Portion]

In the production method described above, an effect of film-forming the cathodes 6A and 6B after providing the convex portion 10 at the entrance of the recessed portion 7 will be described.

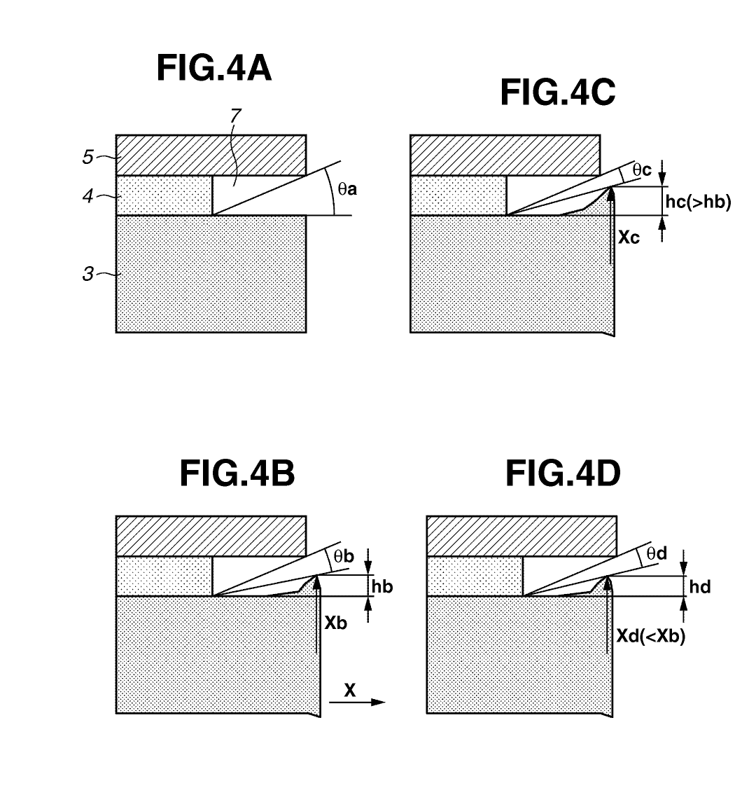

FIG. 4A is a cross-sectional view of the electron emitting device before film-forming the cathodes 6A and 6B. FIG. 4A is a conventional configuration in which the convex portion 10 is not provided at the entrance of the recessed portion 7. When the cathodes 6A and 6B is film-formed by the conventional vacuum film-forming technologies, such as a CVD method, a vacuum deposition method, or a sputtering method after forming the recessed portion 7, an angle of view of cathode particles for reaching a corner of the innermost portion of the recessed portion 7 becomes comparatively wide as 8 a illustrated in FIG. 4A.

With this configuration, the cathode turns into the inner surface of the recessed portion 7 and leak current occurs. For preventing this, the film-forming is often performed by some contrived methods, for example, a slanting deposition is used, a collimator for restricting a flying angle of particles is provided in the film-forming apparatus, and the film-forming is performed in a relatively high vacuum condition (under a low pressure condition) in which the particle scattering is small.

FIGS. 4B to 4D are cross-sectional views of the electron emitting device before film-forming the cathodes 6A and 6B when the convex portion 10 is provided at the entrance of the recessed portion 7. In FIG. 4B, a height of the convex portion 10 at the entrance of the recessed portion 7 is assumed to be hb, and X coordinate at a top edge of the convex portion 10 is assumed to be Xb. By providing the convex portion 10 at the entrance of the recessed portion 7, the angle of view of the cathode particles at the time of film-forming the cathodes 6A and 6B becomes quite small compared with that in FIG. 4A in which the convex portion 10 is not provided.

Further, as illustrated in FIG. 4C, when the height of the convex portion 10 at the entrance of the recessed portion 7 is higher than that in FIG. 4B (hc>hb), the angle of view of the cathode particles to the recessed portion 7 at a time of film-forming the cathodes 6A and 6B becomes small (θc<θb). Further, as illustrated in FIG. 4D, when the top end of the convex portion 10 at the entrance of the recessed portion 7 is provided at a position in a depth direction of the recessed portion 7 with respect to the position in FIG. 4B (Xd<Xb), the angle of view of the cathode particles to the recessed portion 7 at the time of film-forming the cathodes 6A and 6B becomes small (θd<θb).

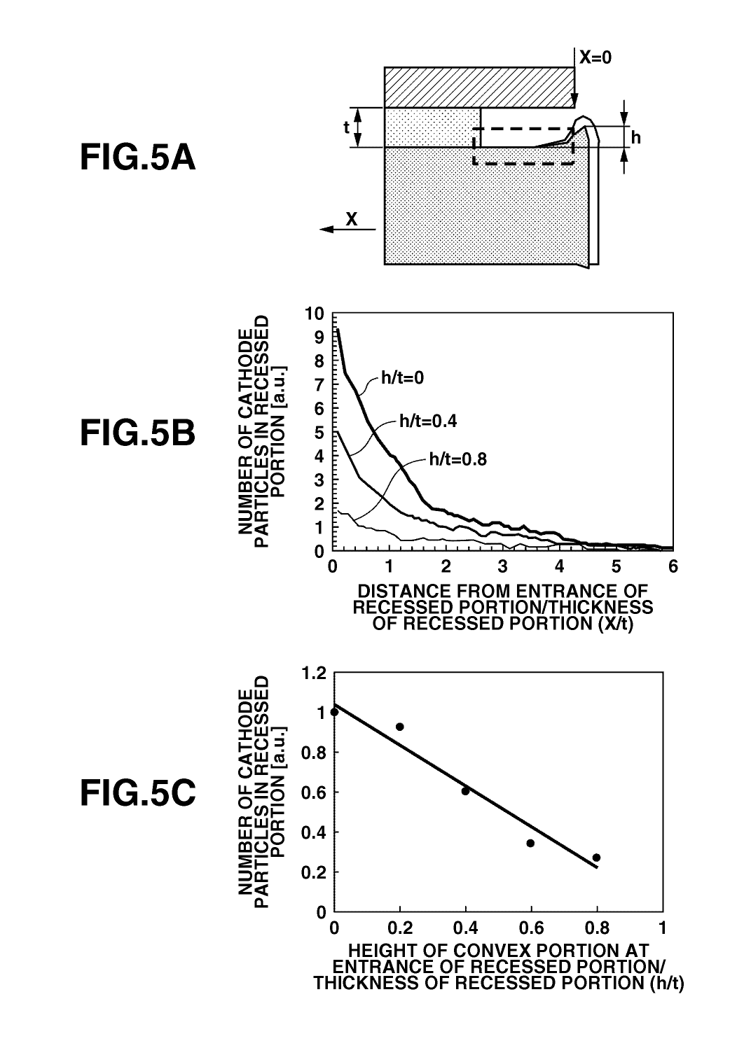

Then, an example of a result of comparison of the turning of the cathode particles into the inner space of the recessed portion 7 is described. FIG. 5A is a cross-sectional view of the electron emitting device. As illustrated in FIG. 5A, the height of convex portion 10 at the entrance of the recessed portion 7 is assumed to be h, and the thickness of the recessed portion? (the thickness of the second insulating layer 4) is assumed to be t. FIGS. 5B and 5C compare the turning of the cathode into the inner space of the recessed portion 7 when the height of the convex portion 10 is changed.

FIG. 5B is a graph illustrating a change of the cathode particle numbers on the surface of the first insulating layer 3 constituting the recessed portion 7 with respect to a distance from the entrance of the recessed portion 7. The horizontal axis represents the normalized distance X from the entrance of the recessed portion 7 by the thickness t of the recessed part 7. FIG. 5C is a graph illustrating a change of the cathode particle number at a certain point on the surface of the first insulating layer 3 constituting the recessed portion 7, when the height h of convex portion 10 at the entrance of the recessed portion 7 is changed.

In FIG. 5C, the horizontal axis represents normalized height h of the convex portion 10 by the thickness t of the recessed portion 7. As illustrated in FIGS. 5B and 5C, when the height h of the convex portion 10 becomes larger than the thickness t of the recessed portion 7, the turning of the cathode into the recessed portion 7 becomes small. Therefore, by providing the convex portion 10 at the entrance of the recessed portion 7, the angle of view of the cathode particles with respect to the recessed portion at a time of film-forming the cathodes 6A and 6B can be controlled, and the turning of the cathode into the recessed portion 7 can be reduced. As a result, the leak current can be reduced.

Further, since the electron emitting device itself includes the leak current reduction mechanism, there are no restrictions on, for example, the apparatus for film-forming the cathode, the film-forming condition, and the cathode material, and thus a suitable selection for a mass production becomes possible.

A first exemplary embodiment will be described as follows.

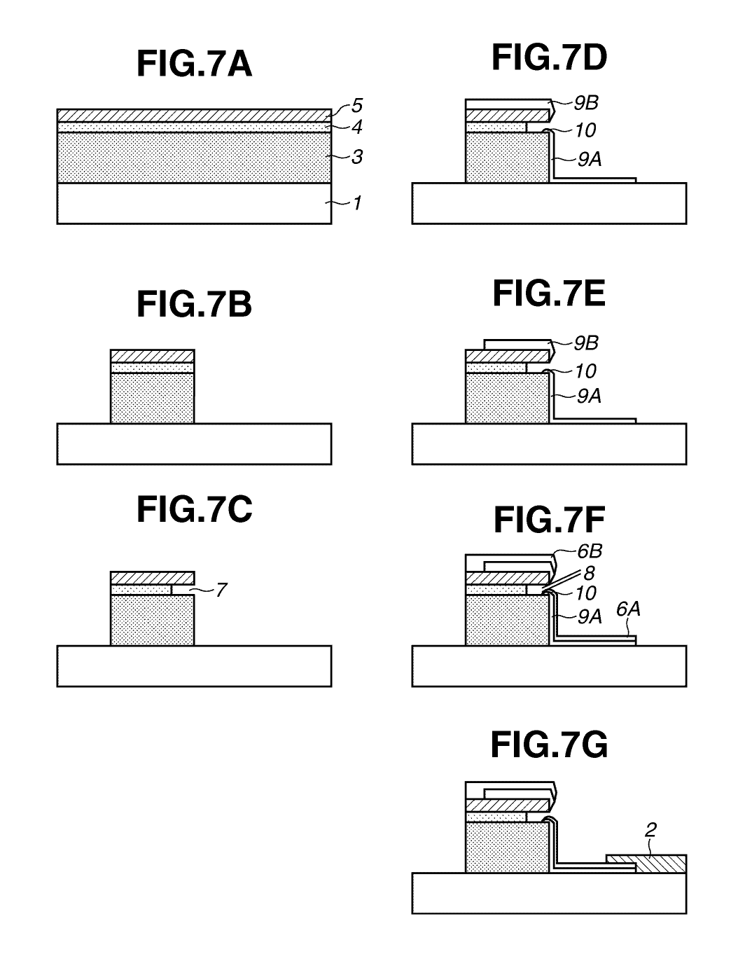

FIGS. 7A to 7G are schematic cross-sectional views illustrating the production method of the electron emitting device according to the first exemplary embodiment. At first, as illustrated in FIG. 7A, the first insulating layer 3, the second insulating layer 4, and the gate electrode 5 are laminated by using a sputtering method in this order. The material of the substrate 1 is PD200, which is a low sodium content glass and developed for a use of a plasma display apparatus. The material of the first insulating layer 3 was SiN (SixNy), and the thickness of the first insulating layer 3 was 500 nm. The material of the second insulating layer 4 was SiO₂, and the thickness of the second insulating layer 4 was 30 nm. The material of the gate electrode 5 was TaN, and the thickness of the gate electrode 5 was 30 nm.

Then, after forming the resist pattern on the gate electrode 5 by using a photolithography technology, as illustrated in FIG. 7B, the gate electrode 5, the second insulating layer 4, and the first insulating layer 3 were processed in this order by using a dry etching method. As a processing gas at this time, a CF₄ based gas was used because the materials of the first insulating layer 3, the second insulating layer 4, and the gate electrode 5 were selected from the materials which can form a fluoride.

As the result of performing RIE using this gas, after etching, the first insulating layer 3, the second insulating layer 4, and the gate electrode 5 were formed with angles of about 80° with respect to the horizontal plane of the substrate. After separating the resist, as illustrated in FIG. 7C, the second insulating layer 4 was etched by an etching method using BHF so that the depth of the recessed portion became to be about 70 nm. As a result, the recessed portion 7 was formed on the insulating member configured by the first insulating layer 3 and the second insulating layer 4.

Then, as illustrated in FIG. 7D, by performing an oblique deposition of the material of the convex portion 10 from the entrance of the recessed portion 7 to on the substrate 1 along the side surface of the first insulating layer 3, the layer 9 was formed. Further, the convex portion 10 extending to the gate electrode 5 at the entrance of the recessed portion 7 was formed. The material of the convex portion 10 was SiO₂, and the height of the convex portion 10 was 18 nm which was 60% of the thickness of the second insulating layer 4.

In addition, at this time, SiO₂ was adhered also on the gate electrode 5 and the layer 9B was formed on the gate electrode 5. Then, as illustrated in FIG. 7E, patterning was performed on the layer 9B on the gate electrode 5, and a part of the gate electrode 5 was exposed so that the gate electrode 5 electrically can connect to the cathode to be film-formed in the next step.

Then, as illustrated in FIG. 7F, by performing the slating film-forming of Mo by a sputtering method from the entrance of the recessed portion 7, in which the convex portion 10 is provided, to on the substrate 1 along the side surface of the first insulating layer 3, and the cathode 6A (a low potential side cathode) was formed. In addition, at this time, Mo was adhered also on the gate electrode 5, and the cathode 6B was film-formed on the gate electrode 5.

The thickness of Mo was formed so as to be 12 nm at a flat plane (a thickness at a surface in which there is no shielding at surroundings, for example, on the gate electrode 5). After forming the cathodes 6A and 6B, the resist pattern was formed so that a width of the cathode 6A became 100 μm, by a photolithography technology.

Then, the cathode 6A consisting of Mo was processed by using a dry etching method. As an etching gas at this time, a CF4 based gas was used. Through this processing, the strip shaped cathode 6A having protrusion parts located at the edge of the recessed portion 7 was formed.

In the present exemplary embodiment, the with of the cathode 6A is equal to the width of the protrusion part. In addition, the width of the protrusion part means a length of the protrusion part, which is in the vertical direction to the depth direction of the recessed part 7 and along the edge of the recessed portion 7. As a result of an analysis by a cross-sectional TEM, the gap 8 between the cathode 6A and the gate electrode 5 in FIG. 7F was 9 nm.

Then, as illustrated in FIG. 7G, electrode 2 was formed by using a sputtering method. The material of the electrode 2 was Cu, and the thickness of the electrode 2 was 500 nm.

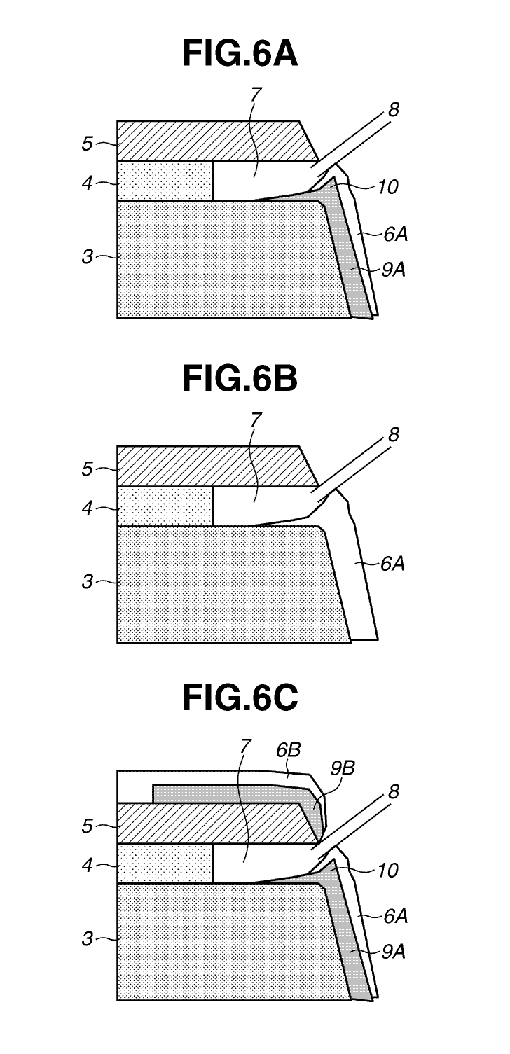

FIG. 6C illustrates the schematic cross-sectional view of the electron emitting device produced by the above-described method. With the configuration in FIG. 2, the characteristics of the electron emitting device was evaluated by using the formula, i.e., efficiency=Ie/(If+Ie). If and Ie are already described, so that the description will be omitted. In a condition in which the potential of the gate electrode 5 was 24 V and the potential of the cathode 6A via electrode 2 was 0 V, the drive voltage of 24 V was applied between the gate electrode 5 and the cathode 6A. Further, Va was 10 kV.

As a result, an average efficiency was 6%. The leak current which did not contribute the electron-emission current was smaller than a detection limit of current, with respect to the electron-emission current. Further, when the device was driven for a long time, a sudden change of If current was hardly observed.

### COMPARATIVE EXAMPLE

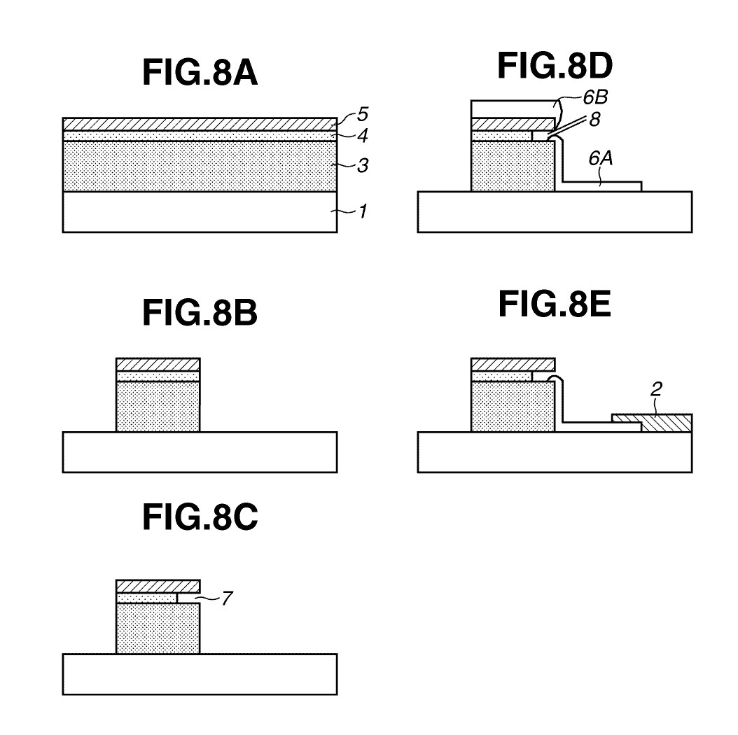

FIGS. 8A to 8E are cross-sectional views illustrating a production method of an electron emitting device of a present comparative example. In the present comparative example, until forming the recessed portion 7, the similar steps in the first exemplary embodiment were performed. After forming the recessed portion 7, as illustrated in FIG. 8D, the film-forming of the cathode 6A was performed without providing the convex portion 10 at the entrance of the recessed portion 7. However, for causing the gap between the low potential side cathode 6A and the gate electrode 5, which affects the electron-emission characteristics, to be equal to the gap in the first exemplary embodiment, the thickness of the cathode 6A was 30 nm. After forming the cathode 6A, as illustrated in FIG. 8E, the similar steps in the first exemplary embodiment are performed to produce the electron emitting device.

FIG. 6B illustrates a schematic cross-sectional view of the electron emitting device produced by using the above-described method. When the same characteristics evaluation in the first exemplary embodiment were performed to this electron emitting device, the leak current which was about 1% of the device current If was detected.

FIG. 3 illustrates a production method of an electron emitting device according to a third exemplary embodiment. In the second exemplary embodiment, until forming the recessed portion 7, the similar steps in the first exemplary embodiment were performed. After forming the recessed portion 7, as illustrated in FIG. 3D, the separation layer 11 was formed on the gate electrode 5. The separation layer 11 was formed on the gate electrode 5 by electrolytic deposition of Ni using an electrolytic plating method.

Then, as illustrated in FIG. 3E, by performing the oblique deposition of the material of the convex portion 10 from the entrance of the recessed portion 7 to on the substrate 1 along the side surface of the first insulating layer 3 by a sputtering method, the layer 9A was formed. The convex portion 10 extending to the gate electrode 5 was formed at the entrance of the recessed portion 7. The material of the convex portion 10 was SiO₂, and the height of the convex portion 10 is 18 nm which is 60% of the thickness of the second insulating layer 4. In addition, at this time, SiO₂ was adhered also on the gate electrode 5 and the layer 9 was film-formed on the gate electrode 5.

Then, as illustrated in FIG. 3F, by performing the oblique deposition of Mo from the entrance of the recessed portion 7, in which the convex portion is provided, to on the substrate 1 along the side surface of the first insulating layer 3 by using a sputtering method, and the cathode 6A (the low potential side cathode) was formed. In addition, at this time, Mo was adhered also on the gate electrode 5, and the cathode 6B was formed on the gate electrode 5. Mo was film-formed so as to have a thickness of 12 nm at the flat plane.

As a result of analysis by the cross-sectional TEM, the gap 8 between the cathode 6A and the gate electrode 5 in FIG. 3F was 9 nm. After film-forming the cathodes 6A and 6B, as illustrated in FIG. 3G, by removing the Ni separation layer 11 deposited on the gate electrode 5 using an etching solution including iodine and potassium iodide, the cathode 6B was separated from the gate electrode 5. After separating the cathode 6B, as illustrated in FIG. 3H, by performing the similar steps in the first exemplary embodiment, the cathode 6A are processed to form the electrode 2, so that the electron emitting device was produced.

FIG. 6A illustrates a schematic cross-sectional view of the electron emitting device produced by the above-described method. The same characteristics evaluation in the first exemplary embodiment was performed to this electron emitting device. As a result of this, the average efficiency was 8%. The leak current which did not contribute the electron-emission current was smaller than the detection limit of current, with respect to the electron-emission current.

Further, when the device was driven for a long time, the sudden change of the If current was hardly observed. In addition to the same effects in the first exemplary embodiment, in the present exemplary embodiment, since the layer 9B and the cathode 6B on the gate electrode 5 were separated, the electrons emitted from the cathode can reach the anode electrode with high efficiency. Therefore, the electron emission efficiency was increased compared with the case in the first exemplary embodiment.

In a third exemplary embodiment, until forming the recessed portion 7, the similar steps in the second exemplary embodiment were performed. After forming the recessed portion 7, as illustrated in FIG. 3D, the separation layer 11 was formed. The separation layer 11 was formed by electrolytic depositing Ni on the gate electrode 5 using an electrolytic plating method. Then, as illustrated in FIG. 3E, by performing the oblique deposition of the material of the convex portion 10 from the entrance of the recessed portion 7 to on the substrate 1 along the side surface of the first insulating layer 3 by a sputtering method, the layer 9 was formed. Further, the convex portion 10 extending to the electrode 5 was also formed at the entrance of the recessed portion 7.

The material of the convex portion 10 was SiN, and the height of the convex portion 10 was 18 nm which was 60% of the thickness of the second insulating layer 4. In addition, at this time, SiN was adhered also on the gate electrode 5, and the layer 9B was formed on the gate electrode 5. Then, as illustrated in FIG. 3F, by performing the oblique deposition of Mo from the entrance of the recessed portion 7, in which the convex portion 10 was provided, to on the substrate 1 along the side surface of the first insulating layer 3 by a sputtering method, the cathode 6A (the low potential side cathode) was formed. In addition, at this time, Mo was adhered also on the gate electrode 5, and the cathode 6B was film-formed on the gate electrode 5.

Mo was film-formed so as to be the thickness of 12 nm at the flat plane. As a result of an analysis of the cross-sectional TEM, the gap 8 between the cathode 6A and the gate electrode 5 in FIG. 3F was 9 nm. After film-forming the cathodes 6A and 6B, as illustrated in FIG. 3G, the Ni separation layer 11 deposited on the gate electrode 5 was removed by the similar method in the second exemplary embodiment, so that the cathode 6B was separated from the gate electrode 5.

After separating the cathode 6B, a resist pattern was formed so that the width of the cathode 6A became 100 μm by a photolithography technology. Then, the cathode 6A consisting of Mo was processed by using a dry etching method. After patterning the cathode 6A, a residual substance adhered on the inner surface of the recessed portion 7 was removed by a lift-off technology using BHF. The etching rate of SiN by BHF is smaller than SiO₂ by an order of magnitude.

In the present exemplary embodiment, since the convex portion 10 at the entrance of the recessed portion 7 was made of SiN, the convex portion 10 was not etched at the time of the BHF treatment. Since the residual substance at the inner surface of the recessed portion 7 causes the leak current, the electron emitting device in the present exemplary embodiment could reduce leak current factors more than the electron emitting device in the second exemplary embodiment. After removing the residual substance, as illustrated in FIG. 3H, the electrode 2 was formed by performing the similar steps in the second exemplary embodiment, so that the electron emitting device was produced.

FIG. 6A illustrates a schematic cross-sectional view of the electron emitting device produced by the above-described method. The same characteristic evaluation in the first exemplary embodiment was performed to this electron emitting device. As a result, the average efficiency was 8%. The leak current which did not contribute to the electron-emission current was smaller than the detection limit current with respect to the electron-emission current. Further, when the device was driven for a long time, a sudden change of the If current was prevented more than that in the case of the second exemplary embodiment.

In a fourth exemplary embodiment, until forming the recessed portion 7, the similar steps in the first exemplary embodiment were performed. After forming the recessed portion 7, as illustrated in FIG. 7D, by performing the oblique deposition of the material of the convex portion 10 from the entrance of the recessed portion 7 to on the substrate 1 along the side surface of the first insulating layer 3 by a sputtering method, the layer 9A was formed. Further, the convex portion 10 extending to the gate electrode 5 was formed at the entrance of the recessed portion 7.

The material of the convex portion 10 was SiO₂, and the height of the convex portion 10 was 25 nm which was 85% of the thickness of the second insulating layer 4. In addition, SiO2 was adhered also on the gate electrode 5 and the layer 9B was film-formed on the gate electrode 5.

Then, as illustrated in FIG. 7E, by performing patterning of the layer 9 on the gate electrode 5, a part of the gate electrode 5 was exposed so as to enable the gate electrode 5 to be electrically connected to the cathode to be film-formed in the next step. Then, as illustrated in FIG. 7F, by performing the oblique deposition of Mo from the entrance of the recessed portion 7, in which the convex portion 10 was provided, to on the substrate 1 along the side surface of the first insulating layer 3 by a sputtering method, the cathode 6A (the low potential side cathode) was formed. In addition, at this time, Mo was adhered also on the gate electrode 5, and the cathode 6A was film-formed on the gate electrode 5. Mo was film-formed so as to be the thickness of 5 nm at the flat plane.

Then, the cathode 6A was processed by performing the similar steps in the first exemplary embodiment. As a result of analysis by the cross-sectional TEM, the gap 8 between the low potential side cathode 6A and the gate electrode 5 in FIG. 7F was 9 nm. Then, as illustrated in FIG. 7G, the electrode 2 was formed by a sputtering method. The material of the electrode 2 was Cu and the thickness of the electrode 2 was 500 nm.

FIG. 6C illustrates a schematic cross-sectional view of the electron emitting device produced by the above-described method. The same characteristic evaluation in the first exemplary embodiment was performed to this electron emitting device. As a result of this, the average efficiency was 3%. In this electron emitting device, the thickness of the cathode was decreased and the resistance of the cathode was increased, so that the potential of the cathode 6A becomes lower than 24V. From this reason, it is considered that the efficiency of the device in the present exemplary embodiment becomes lower than the device in the first exemplary embodiment.

The leak current which did not contribute to the electron-emission current was smaller than the detection limit of current with respect to the electron-emission current. Further, when the device was driven for a long time, a sudden change of the If current was hardly observed.

In a fifth exemplary embodiment, until forming the recessed portion 7, the similar steps in the first exemplary embodiment were performed. After forming the recessed portion 7, as illustrated in FIG. 7D, by performing the oblique deposition of the material of the convex portion 10 from the entrance of the recessed portion 7 to on the substrate 1 along the side surface of the first insulating layer 3 by the sputtering method, the layer 9A was formed. Further, the convex portion 10 extending to the gate electrode 5 was formed at the entrance of the recessed portion 7.

The material of the convex portion 10 was SiO₂, and the height of the convex portion 10 was 15 nm which was 50% of the thickness of the second insulating layer 4. In addition, SiO₂ was adhered also on the gate electrode 5, and the layer 9B was film-formed on the gate electrode 5. Then, as illustrated in FIG. 7E, patterning of the layer 9B on the gate electrode 5 was performed, and a part of the gate electrode 5 was exposed so as to enable the gate electrode 5 to be electrically connected to the cathode which was film-formed in next step.

Then, as illustrated in FIG. 7F, by performing the oblique deposition of Mo from the entrance of the recessed portion, in which the convex portion 10 was provided, to on the substrate 1 by a sputtering method and formed the cathode 6A (the low potential side cathode). In addition, at this time, Mo was adhered also on the gate electrode 5, and the cathode 6B was film-formed on the gate electrode 5.

Mo was film-formed so as to have the thickness of 15 nm at the flat plane. Then, the cathode 6A was processed by performing the similar steps in the first exemplary embodiment. As a result of analysis by using the cross-sectional TEM, the gap 8 between the low potential side cathode 6A and the gate electrode 5 in FIG. 7F was 9 nm. Then, as illustrated in FIG. 7G, the electrode 2 was formed by a sputtering method. The material of the electrode 2 was Cu, and the thickness of the electrode 2 was 500 nm.

FIG. 6C illustrates a schematic cross-sectional view of the electron emitting device produced by the above-described method. The same characteristic evaluation in the first exemplary embodiment was performed to this electron emitting device. As a result of this, the average efficiency was 6%. The leak current which did not contribute to the electron-emission current was about 0.1% with respect to the electron-emission current. The reason of this is considered that since the shield effect of the cathode material to the inside of the recessed portion 7 becomes small, the leak current is increased.

In a sixth exemplary embodiment, until forming the recessed portion 7, the similar steps in the first exemplary embodiment were performed. After forming the recessed portion 7, as illustrated in FIG. 7D, by performing the oblique deposition of the material of the convex portion 10 from the entrance of the recessed portion 7 to on the substrate 1 along the side surface of the first insulating layer 3 by a sputtering method, the layer 9A was formed. Further, the convex portion 10 extending to the gate electrode 5 was also formed at the entrance of the recessed portion 7.

The material of the convex portion 10 was Si, and the height of the convex portion 10 was 18 nm which was 60% of the second insulating layer 4. In addition, Si was adhered also on the gate electrode 5, and the layer 9B was film-formed on the gate electrode 5. Then, as illustrated in FIG. 7E, patterning of the layer 9B was performed on the gate electrode 5, and a part of the gate electrode 5 was exposed so as to enable the gate electrode 5 to be electrically contacted to the cathode to be film-formed in the next step.

Then, as illustrated in FIG. 7F, by performing the oblique deposition of Mo from the entrance of the recessed portion 7, in which the convex portion 10 was provided, to on the substrate 1 along the side surface of the first insulating layer 3 by a sputtering method, the cathode 6A (the lower potential side cathode) was formed.

In addition, at this time, Mo adhered also on the gate electrode 5, and the cathode 6B was film-formed on the gate electrode 5. Mo was film-formed so as to have the thickness of 12 nm at the flat plane. Then, the cathode 6A was processed by performing the similar steps in the first exemplary embodiment. As a result of analysis by using the cross-sectional TEM, the gap 8 between the lower potential side cathode 6A and the gate electrode 5 in FIG. 7F was 9 nm. Then, as illustrated in FIG. 7G, the electrode 2 was formed by the sputtering method. The material of the electrode 2 was Cu, and the thickness of the electrode 2 was 500 nm.

FIG. 6C illustrates a schematic cross-sectional view of the electron emitting device produced by the above-described method. The same characteristic evaluation in the first exemplary embodiment was performed to this electron emitting device. As a result of this, the average efficiency was 6%. The leak current which did not contribute to the electron-emission current was smaller than the detection limit of current with respect to the electron-emission current.

In a seventh exemplary embodiment, a large number of electron emitting devices produced by performing the similar steps in the second exemplary embodiment were arranged in a matrix manner on a substrate to form an electron source substrate. An image display apparatus was produced by using the electron source substrate.

At first, SiN/SiO₂/TaN/SiO₂/Mo layers were film-formed sequentially on a glass substrate 13 by performing the similar steps in the second exemplary embodiment, and an electron emitting device 23 was produced.

Then, a Y direction wiring 18 was arranged so as to be connected to the gate electrodes. The Y direction wiring functions as a wiring, in which a modulation signal is applied. Then, for insulating an X direction wiring 14 and the Y direction wiring 18, an insulating layer made of silicon oxide was arranged. The X direction wiring 14 was produced in the next step. This insulating layer was arranged so as to be under the X direction wiring 14 and to cover the Y direction wiring 18.

Then, the X direction wiring 14 was formed on the insulating layer which was arranged before. The X direction wiring 14 functions as a wiring, in which a scanning signal is applied, and includes silver as a main component. The X direction wiring 14 was arranged with the insulating layer interposed between the X direction wiring 14 and the Y direction wiring 18, and intersecting to the Y direction wiring 18. With this configuration, a glass substrate 13 having matrix wirings was produced.

Then, at 2 mm upper side of the glass substrate 13, a face plate 22 was arranged via the supporting frame 16. The face plate 22 was formed on the inner face of a glass substrate 19 by laminating a phosphor film 20 and a metal back 21. The phosphor film 20 was a light-emitting member and the metal back 21 was an anode electrode.

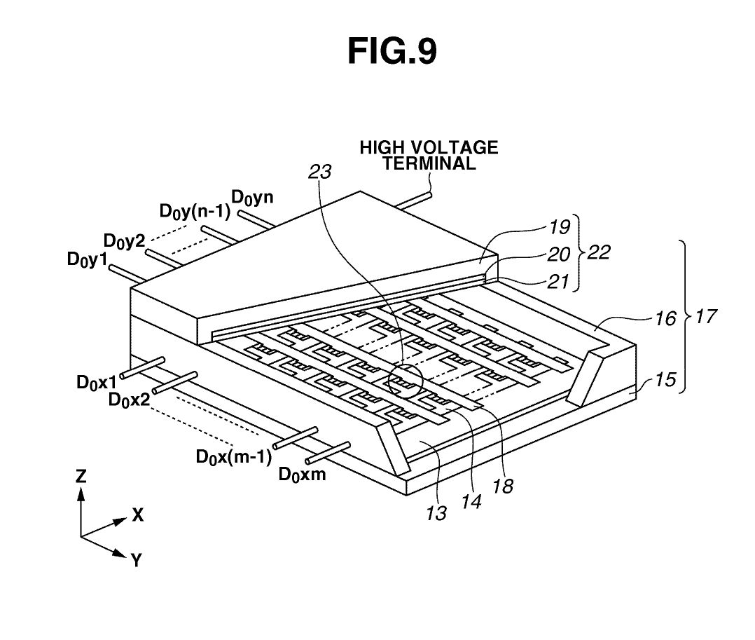

In addition, FIG. 9 illustrates an example in which a rear plate 15 configuring a container 17 is provided as a support member of the glass plate 13. However, in the present exemplary embodiment, the rear plate 15 was omitted. Joining parts of the face plate 22, the support member 16, and the glass plate 13 were sealed and joined by heating indium (Id) and cooling. Id is a low melting point metal. The sealing and joining processes were performed in a vacuum chamber, so that the sealing and joining processes were simultaneously performed without an exhaust pipe.

In the present exemplary embodiment, the phosphor film 20 which was a image forming member was a phosphor having a stripe shape for realizing a color image. The phosphor film 20 was formed by forming black strips (not illustrated) at first and coating each color phosphor (not illustrated) in gap parts of the black strips by using a slurry method. As a material of the black strip, a conventionally used material including graphite as a main component is used. Further, at an inner surface side of the phosphor film 20 (an electron emitting device side), the metal back 21 consisting of Al is provided. The metal back 21 is produced by vacuum-evaporating Al to the inner surface side of the phosphor film 20.

The image display apparatus made by the above-described method can realize the display apparatus having a stable displaying image. The embodiments above may be directed to an easy and simple production methods of an electron-emission device which reduces occurrence of the leak current between the gate and the cathode, and may perform a steady operation, an electron beam apparatus using the electron-emission device, and an image display apparatus using the electron beam apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-093791 filed Apr. 15, 2010, which is hereby incorporated by reference herein in its entirety.

What is claimed is:

1. A method of an electron emitting device including an insulating member with a concave portion on a surface thereof, a gate electrode formed on a surface of the insulating member and arranged to face the concave portion, and a cathode including a protrusion portion protruding to the gate electrode and arranged at an edge of the concave portion, the method comprising in the following order:
forming the concave portion; and
forming the cathode after forming a convex portion formed at the edge of the concave portion and protruding to the gate electrode.

2. The method according to claim 1,
wherein the convex portion is formed by using a material having insulating property or a high electric resistance of resistivity of 10⁻⁴ Ωm or more.

3. The method according to claim 1,
wherein the convex portion is film-formed by a vapor deposition method.

4. The method according to claim 1,
wherein a material of the convex portion is simultaneously film-formed also on the gate electrode when the convex portion is formed,
a material of the cathode is simultaneously film-formed also on the gate electrode when the cathode is formed,
after the cathode is formed, the material of the convex portion film-formed on the gate electrode and the material of the cathode film-formed on the gate electrode are separated.

5. A method of an electron beam apparatus including an electron emitting device and an anode electrode, the method comprising:
producing the electron emitting device according to claim 1, and
arranging the anode electrode opposing an top end of the cathode.

6. A method of an image display apparatus including an electron beam apparatus and a light emitting member, the method comprising:
producing the electron beam apparatus according to claim 5,
wherein a light emitting member and the anode electrode are laminated.

7. An electron emitting device comprising:
an insulating member with a concave portion on a surface thereof;
a gate electrode formed on a surface of the insulating member and arranged to face the concave portion; and a cathode including a protrusion portion protruding to the gate electrode and arranged at an edge of the concave portion; and
a convex portion formed at the edge of the concave portion and protruding to the gate electrode.

8. The device according to claim 7,
wherein the convex portion is made of a material having insulating property or a high electric resistance of resistivity of 10⁻⁴ Ωm or more.

9. The device according to claim 7,
wherein the convex portion is film-formed.

10. The device according to claim 7,
wherein a material of the convex portion, the cathode and the gate electrode is film-formed.
